(19) United States
(12) Patent Application Publication
(10) Pub. No.: US 2017/0368765 A1
(43) Pub. Date: Dec. 28, 2017

(54) ASSEMBLY FOR THE FULL-SURFACE ADHESIVE BONDING OF SUBSTANTIALLY CONGRUENT ADHESIVE-BONDING SURFACES OF A FIRST AND A SECOND JOINING PARTNER

(71) Applicant: PREH GMBH, Bad Neustadt a.d. Saale (DE)

(72) Inventor: Michael MARTIN, Unsleben (DE)

(73) Assignee: PREH GMBH, Bad Neustadt a. d. Saale (DE)

(21) Appl. No.: 15/543,453

(22) PCT Filed: Jan. 15, 2016
(86) PCT No.: PCT/EP2016/050719

§ 371 Date: Jul. 13, 2017

(30) Foreign Application Priority Data
Jan. 16, 2015 (DE) 10 2015 100 635.9

(51) Int. Cl. B29C 65/52; B29C 65/48; B29C 65/78; C09J 5/00; B29C 65/00; B29C 65/54

(52) U.S. Cl. CPC B29C 65/524; B29C 66/81262; B29C 65/548; B29C 65/7847; C09J 5/00; B29C 66/8322; B29C 65/4845; B29C 66/723; B29C 66/71; B29C 66/342; B29K 2995/0007; C09J 2433/00; C09J 2483/00

(57) ABSTRACT

The invention relates to an assembly for adhesively connecting substantially congruent gluing surfaces of a first and second joining partner over their full surface, comprising: the first joining partner (1); the second joining partner (2); an adhesive layer (3) of a polar, flowable adhesive applied to the gluing surface (1a) of the first joining partner (1); means (8) for holding the second joining partner (2) above the adhesive layer (1a) of the first joining partner (1), such that the gluing surface (2a) of the second joining partner (2) faces the adhesive layer (3) on the first joining partner (1) and is disposed so as to be spaced therefrom across an air gap (5), and the spacing defined by the air gap (5) between the first joining partner (1) and the second joining partner (2) is dimensioned in such a way that a capillary volume is formed; means (7) for generating an electric field (10) in order to cause, by means of electric influence, a local charge displacement (11) on and/or in the second joining partner (1), and the charge displacement (11) is suitable for attracting the polar adhesive in such a way that it wets the gluing surface (2a) of the second joining partner (2) first in the area of the local charge displacement (11), wherein the means for generating the electric field comprise an electrode (7), which is disposed on the side of the second joining partner (2) facing away from the gluing surface (2a) and is electrically insulated from said partner (2).

### TECHNICAL FIELD

The invention relates to an assembly and a method for adhesively connecting substantially congruent gluing surfaces of a first and second joining partner, in particular for adhesively connecting an outer layer of a display device, for example a polarization film with a transparent protective layer, for example consisting of polycarbonate, preferably of polymethylmetacrylate (PMMA).

### BACKGROUND

The adhesive connection of two joining partners is generally subject to the requirement of spreading the adhesive as uniformly as possible and as thinly as possible between the joining partners and avoiding inclusions of air in the process. This problem is particularly relevant if a transparent layer is to be applied to a display device. In this case, a common procedure is to bend one of the joining partners in such a way that the gluing surface curves away from the other gluing surface, so that, if one of the gluing surfaces is previously coated with an adhesive and if the gluing surfaces are brought closer to each other until the adhesive layer is contacted by the other gluing surface, a local, mostly linear contact occurs, which then gradually expands to result in a full-surface adhesive connection when the curvature is relieved. Though this procedure is suitable for flexible films, it is unsuitable for comparatively thick protective layers. Furthermore, there is a danger of a local excessive mechanical stress on the bent joining partner. Wetting by applying an electric field between the joining partners is also known in the production of optical storage media. This procedure entails the risk of damaging the joining partners by directly contacting them.

### DETAILED DESCRIPTION

Therefore, the object of the invention is to provide an assembly and a method for adhesively connecting two joining partners, in which a uniform and continuous adhesive layer is formed comparatively easily between the joining partners, so that inclusions of air in the adhesive layer are avoided and, in particular, the mechanical and electrical stress on the joining partners is minimized. The object is achieved by an assembly according to claim 1 and by a method of the independent claim. Advantageous embodiments are in each case the subject matter of the dependent claims. It must be remarked that the features cited individually in the patent claims can be combined in any technologically meaningful manner and depict other embodiments of the invention. The description, in particular in connection with the figures, additionally characterizes and specifies the invention.

According to the invention, the inventive assembly for adhesively connecting substantially congruent, for example planar, parallel gluing surfaces of a first and second joining partner comprises a first joining partner and a second joining partner with associated gluing surfaces. A gluing surface is the surface of the respective joining partner that is intended for adhesive connection and, ultimately, is to be wetted with adhesive. Furthermore, the assembly comprises an adhesive layer of a flowable, polar adhesive applied to the gluing surface of the first joining partner. According to the invention, an adhesive that can be polarized as such and that was polarized in a preceding processing step, is also supposed to be included. Preferably, however, the adhesive as such is polar, so that an additional polarization can be omitted. Generally, the polarity of the adhesive is the result of its molecular structure; for example, acrylate-based adhesives exhibit a high polarity. On the one hand, the polarity ensures a high strength of the adhesive layer by means of cohesion; according to the invention, however, it plays an essential role in the subsequent wetting of the first joining partner, as will be described below.

According to the invention, means for holding the second joining partner above the first joining partner are also provided, so that the gluing surface of the second joining partner faces the adhesive layer of the first joining partner and is disposed so as to be spaced therefrom across an air gap. For example, these means include means generating negative pressure in order to hold the second joining partner by means of negative pressure. Preferably, the means are configured so that a parallel orientation of the gluing surfaces of the joining partners is obtained.

According to the invention, the assembly is such that a spacing, hereinafter also referred to as minimum spacing, is maintained between the first and second joining partners, in particular between the gluing surface of the second joining partner and the adhesive layer, which is selected in such a way that a capillary volume, preferably an open, i.e. laterally accessible capillary volume, is formed between the joining partners, and that, in particular, the second joining partner is not yet contacted and thus wetted.

For example, the distance is in the rage of 0.08 to 3.0 mm, preferably in the range of 0.1 to 1.0 mm.

According to the invention, means for generating an electric field are also provided in order to cause, by means of electric influence, also referred to as electrostatic induction, a local charge displacement on and/or in the second joining partner, for example by displacing free charge carriers, by means of induced polarization and/or by orientation polarization. According to the invention, the charge displacement is supposed to be suitable for attracting the polar adhesive in such a way that it wets the gluing surface of the second joining partner first in the area of the local charge displacement. According to the invention, the means for generating the electric field comprise an electrode, which is disposed on the side of the second joining partner facing away from the gluing surface and is electrically insulated from said partner. For example, there is no direct touching contact between the electrode and the second joining partner because an air gap is provided between the electrode and the second joining partner; more preferably, an electric insulator consisting of plastic is provided between the electrode and the second joining partner. The material property of electric insulation in the sense of the invention means a conductivity in the range of 10⁻¹⁰ to 10⁻¹⁸ S·cm⁻¹.

According to another embodiment, means for applying the adhesive to the gluing surface of the first joining partner are also provided. For example, the means are configured for a full-surface application of the adhesive to the gluing surface of the first joining partner. Preferably, in particular in an assembly for automatically carrying out the application, the means comprise a nozzle which automatically moves across the gluing surface and via which the adhesive is applied. In the process, the application can be carried out continuously or intermittently. For example, the location, the duration and the quantity (discharge speed) of the application is selected in such a way, depending on the flowability of the adhesive, that the gluing surface is wetted with adhesive as uniformly as possible, at least after a predetermined period of time. “Uniform” means a layer thickness of the adhesive layer that is continuously largely consistent, apart from a decrease in the area of the edges. Preferably, the means are configured in such a way that the adhesive is applied to the gluing surface in the shape of a bone.

Preferably, the means for holding the second joining partner comprise a receiving portion defining a contact surface for the second joining partner, wherein the electrode is completely or partially embedded in the receiving portion. Preferably, the means for holding the second joining partner comprise a vacuum holding device. For example, through-holes are provided in the contact surface in order to hold the second joining partner by applying a vacuum.

Preferably, the receiving portion is made from a plastic, preferably a polymer, more preferably a polyetherketone, such as polyaryletherketone, a polyhaloolefin; such as polytetrafluoroethylene, and/or a polyoxymethylene, such as a polyoxymethylene homopolymer. On the one hand, a sufficient electrical insulation is thus obtained, but, at the same time, an effective charge displacement in the second joining partner.

Preferably, the electrode has a pointed end pointing towards the gluing surface of the second joining partner.

Preferably, the second joining partner is configured to be transparent, and the adhesive of the adhesive layer is configured to cure or harden in a transparent manner.

Preferably, the first joining partner is a display device, and the gluing surface is defined by an outer layer covering a display surface of the display device.

According to a preferred embodiment, the second joining partner is a flat structure, preferably a transparent flat structure, for example made from a transparent plastic or silicate glass. For example, it is a plane-parallel plate with a thickness of 1 mm or more, for example, 3 mm, 4 mm, or 5 mm to 10 mm.

Preferably the second joining partner has a layer of polymethylmetacrylate (PMMA). In another embodiment, the second joining partner is a layer structure with at least one layer of polymethylmetacrylate and at least one further layer of a plastic, glass and/or metal. At least one conductive layer is provided, for example, which is disposed adjacent to the layer of polymethylmetacrylate (PMMA).

Preferably, the adhesive of the adhesive layer, at least during application, has a viscosity selected from the range of 500 mPas and 5000 mPas.

Preferably, the adhesive of the adhesive layer is a chemically hardening adhesive, because one of the following reaction adhesives, for example, is used: epoxy adhesive, polyisocyanate adhesive, cyanoacrylate adhesive, methacrylate adhesive, adhesive with unsaturated polyester, adhesive based on silicone resin, phenol-formaldehyde resin adhesive, urea-formaldehyde resin adhesive, polyimide adhesive, polybenzimidazole adhesive, melamine-formaldehyde resin adhesive, resorcinol formaldehyde resin adhesive and the like. Preferably, it is a polymerization adhesive, such as a methyl methacrylate adhesive or a cyanoacrylate adhesive, or a polyaddition adhesive, such as an adhesive based on silicone polymer.

Preferably, the adhesive is a single-component, dual-curing compound, which is liquid at room temperature and can be cross-linked by actinic radiation and moisture, wherein the compound includes at least one bond with one to four alpha(alkoxy)silane groups, excepting, however, polyolefins substituted with alpha(alkoxy)silane groups.

According to a preferred embodiment, means for partially curing and/or hardening the adhesive layer are furthermore provided. Partial curing is understood to be a spatially limited curing or hardening, i.e. not a full-surface curing or hardening of the adhesive layer, which is a result of the orientation of these means. The means are configured in such a way that, at least with regard to the intensity, only a part of the composite, and not the entire composite, is covered, preferably due to the direction of irradiation. For example, these means are directed towards the edge region and/or the end faces of the composite consisting of the first and second joining partners including the adhesive layer. The design of the means is determined depending on the type and the cross-linking mechanisms of the adhesive used. For example, the means generate light in the visible range or in the ultraviolet range, or thermal radiation, such as microwaves. By curing or hardening only in some portions, a pre-fixation of the adhesive layer is achieved and thus, further running of the adhesive is achieved. This is advantageous particularly at the edge of the composite, because the optical properties would otherwise be affected by air inclusions. On the other hand, due to the merely partial impact and the direct impact of the radiation on the adhesive layer on the end face, a comparatively more intensive and short-term radiation exposure may be chosen without the optical properties of the adhesive layer being adversely affected.

The invention further relates to a method for adhesively connecting substantially congruent gluing surfaces of a first and second joining partner over their full surface, comprising the following steps. In a providing step, the first and second joining partners with the associated gluing surfaces are provided.

In a subsequent application step, a polar, flowable adhesive is applied, which forms the flowable adhesive layer on the gluing surface of the first joining partner. For example, the adhesive is applied to some portions of the gluing surface of the first joining partner in order then to automatically spread across the full surface due to a running process. Preferably, adhesive is applied to the respective gluing surface in the shape of a bone. In automated methods, the adhesive may be applied by means of a nozzle moving across the gluing surface. In the process, the application can be carried out continuously or intermittently. For example, the location, duration and quantity (discharge speed) of the application is selected in such a way, depending on the flowability of the adhesive, that the gluing surface is wetted with adhesive as uniformly as possible, at least after a predetermined period of time. “Uniform” means a layer thickness of the adhesive layer that is continuously largely consistent, apart from a decrease in the area of the edges.

In an arranging step, the first joining partner and the second joining partner are arranged in such a way that the gluing surface of the second joining partner faces the adhesive layer and is spaced therefrom across an air gap. The joining partners are, for example flat structures that are each accommodated in a receiving portion, with an orientation with horizontal gluing surfaces that face each other being obtained. The gluing surfaces are formed congruently; for example, both are formed in a planar manner or have a parallel curvature. For example, a minimum spacing between the gluing surface of the second joining partner and the adhesive layer is maintained in the arranging step. A minimum spacing in the sense of the invention means a spacing chosen in such a way that a contact, and thus a wetting, does not quite occur yet. According to the invention, the spacing or minimum spacing is dimensioned in such a way that a capillary volume is formed between the joining partners despite the adhesive layer.

In a field-generating step, an electric field is generated by an electrode, which is disposed on the side of the second joining partner facing away from the gluing surface and is electrically insulated therefrom, in order to cause, by means of electric influence, a local charge displacement on and/or in the second joining partner.

In a wetting step, a first wetting of the gluing surface of the second joining partner in the region of the local charge displacement takes place by the polar adhesive being attracted in the direction of the second joining partner due to the charge displacement. According to the invention, the wetting according to the invention implies a transition of the adhesive layer onto the second joining partner, i.e. an adhesive transfer onto the gluing surface of the second joining partner, without the adhesive layer becoming detached from the gluing surface of the first joining partner. Further, a spatially limited, i.e. local, wetting is desired according to the invention, in order to avoid air inclusions. Thus, the local wetting serves as a “seed” for the further full-surface wetting of the gluing surface of the second joining partner.

In a subsequent spreading step, a full-surface spreading of the adhesive and a full-surface wetting of the gluing surface of the second joining partner, starting from the location of the local wetting, takes place. If necessary, a full-surface wetting of the gluing surface of the first joining partner takes place now, unless its gluing surface was not completely wetted during the application step, which is the case, for example, given a bone-shaped application. According to the invention, spreading takes place starting from the location of the local wetting by means of capillary force, possibly supported by other forces, such as electrostatic forces, whereby the capillary volume between the gluing surfaces of the joining partners is finally filled substantially completely with adhesive. Therefore, as described above, the spacing between the first and second joining partner in the arranging step is preferably minimized in such a way that no wetting of the first joining partner occurs without the charge displacement, but that an automatic spreading of the adhesive occurs due to the capillary effect if wetting takes place.

This is followed by a curing or hardening step, in which the curing or hardening of the adhesive layer occurs.

It therefore falls to the person skilled in the art, by means of a few experiments, to suitably adjust the strength of the electric field and the above-mentioned spacing, depending on the flowability (viscosity), polarity and surface tension of the adhesive and the wetting characteristics of the surfaces, in order to form the capillary volume. Preferably, the first and/or the second joining partner are made from a polar material in order to improve the wetting action by the adhesive.

By means of the procedure according to the invention, a layer structure including the two joining partners and the adhesive layer is obtained in which the adhesive layer is spread with maximum homogeneity, in particular without any inclusions of air, between the joining partners. Not only is a durable connection between the joining partners obtained in this way, but, if at least one joining partner is transparent, also a visually attractive appearance of the adhesive layer and—if the adhesive layer is transparent—of the gluing surface located underneath it in the viewing direction.

According to an advantageous embodiment of the method, the step of generating an electric field precedes the wetting step in time; in other words, the electric field is switched off prior to wetting in order to cause the wetting by means of the local charge displacement remaining thereafter.

Because of the advantages in an optical respect resulting from the method according to the invention, it is provided in a preferred embodiment that the first joining partner is defined by a, preferably outer, layer of a display device. For example, it is a polarization film of the display device that defines the gluing surface of the first joining partner.

According to a preferred embodiment, the relative spatial relationship of the joining partners is retained during the full-surface spreading step. For example, no mechanical interaction is intended with one of the joining partners in such a manner that a displacement of the adhesive located between the joining partners is caused. Because no, or at least only minimal, mechanical interaction with the joining partners takes place, a tension-free adhesive connection can be obtained.

Preferably, it is provided that the step of curing or hardening includes a first step of partial curing or hardening the adhesive layer and a second subsequent step of the further, preferably full-surface curing or hardening of the adhesive layer, and that further, an intermediary removing step, i.e. a step interposed between the first and second steps, is provided, in which the composite of the first and second joining partners and the adhesive layer is removed from the means for holding the second joining partner and/or the electrode, in order thus to cause, in the second step, a full-surface curing or hardening of the adhesive layer, for example.

Partial curing is understood to be a spatially limited curing or hardening, i.e. not a full-surface curing or hardening of the adhesive layer, which is a result of the orientation of these means. The means are configured in such a way that, at least with regard to the intensity, only a part of the composite, and not the entire composite and thus the entire adhesive layer, is covered, preferably due to the direction of irradiation. For example, these means are directed towards the edge region and/or the end faces of the composite consisting of the first and second joining partners including the adhesive layer, in particular towards the adhesive layer directly exposed at the end faces. The design of the means is determined depending on the type of adhesive and its cross-linking mechanisms. For example, the means generate light in the visible range or in the ultraviolet range, or thermal radiation, such as microwaves. By curing or hardening only in some portions, a pre-fixation of the adhesive layer is achieved and thus, further running of the adhesive is limited or suppressed. This is advantageous particularly at the edge of the composite, because the optical properties would otherwise be affected by air inclusions. On the other hand, due to the merely partial impact and possibly because of the direct impact of the radiation on the adhesive layer exposed at the end face, a comparatively more intensive and short-term radiation exposure may be chosen without the optical properties of the adhesive layer, in particular the remaining adhesive layer, being adversely affected. For example, the radiation density of the radiation generated by the above-mentioned means is greater in the first step than in the second step.

The invention is explained in more detail with reference to the following FIGURE. The FIGURE is to be understood only as an example and merely represents a preferred embodiment. In the drawing:

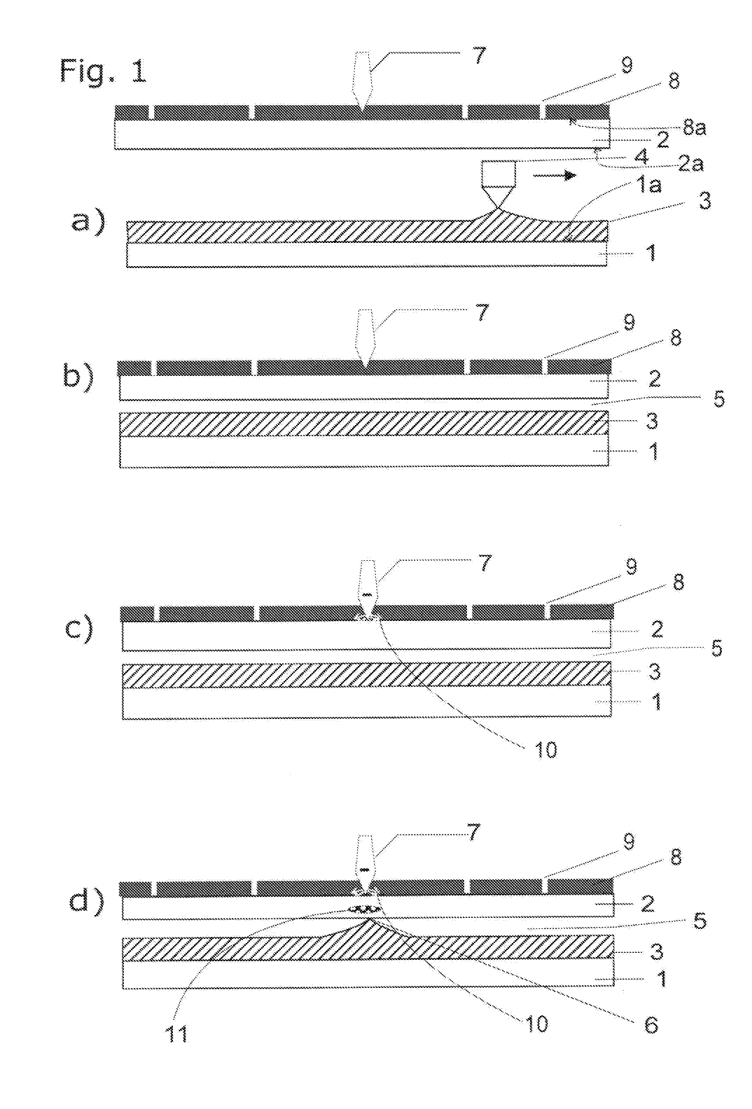

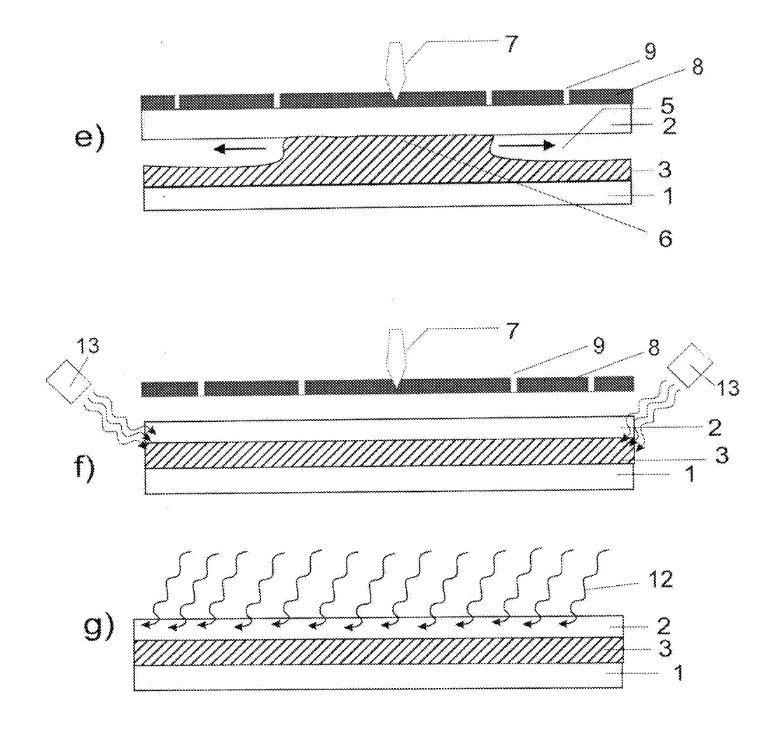

FIG. 1 shows a schematic flow chart of the method according to the invention and of the assembly according to the invention for carrying out the method.

The method according to the invention and the assembly according to the invention shown in FIG. 1 serve for adhesively connecting substantially flat parallel gluing surfaces of a first joining partner 1 and a second joining partner 2. In a first step shown in FIG. 1a), the first joining partner 1 and the second joining partner 2 are provided, which are respectively shown in a sectional view. These are two planar flat structures, with 1 being a layer structure of an LCD or OLED display device. The second joining partner 2 is a transparent pane of a transparent plastic, such as PMMA or a silicate glass. The two flat structures 1, 2 are configured in such a way that the associated gluing surfaces 1a, 2a face each other. In addition, a receiving portion 8 made from polytetrafluoroethylene is provided against which the second joining partner 2 rests due to a vacuum holding device 9. Of the vacuum holding device 9, only the through-holes 9 in the receiving portion 8 are shown via which the second joining partner 2 is held by suction due to the generated vacuum. An electrode 7 for generating an electric field 10, as will be explained later in FIG. 1c, is embedded into the receiving portion 8 in such a way that there is no touching contact with the joining partner 2 and, due to the electrical insulating property of the material chosen for the receiving portion 8, in this case PTFE, also no electric contact with the second joining partner 2. The electrode 7 has a pointed end pointing perpendicularly in the direction of the gluing surface 2a of the second joining partner 2 for concentrating the field strength. In the present case, the electrode 7 is disposed centrally, i.e. above the geometrical center of the adhesive surface 2a on the far side of the second joining partner 2. In each case, the gluing surface 1a, 2a is configured to be planar.

The method according to the invention shown in FIG. 1a) further comprises the step of applying a flowable, transparently hardening adhesive, which is polar on a molecular level, as an adhesive layer 3 to the gluing surface 1a of the first joining partner 1. Preferably, the adhesive is applied in the shape of a bone, with full-surface spreading taking place due to an automatic subsequent running and spreading. In the automatic method or assembly shown, the adhesive is applied by means of a nozzle 4 moving across the gluing surface. The location, duration, quantity and the speed of the nozzle discharge during application is selected in such a way, for example, depending on the flowability (viscosity) of the adhesive, that the result is a uniform wetting of the gluing surface of the first joining partner 1 with adhesive, at least after a predetermined period of time. “Uniform” means a layer thickness of the resulting adhesive layer 3 that is continuously largely consistent, apart from a decrease in the area of the edges.

The method according to the invention comprises the step, shown in FIG. 1b), of arranging the first joining partner 1 and second joining partner 3 in such a way that the gluing surface 2a of the second joining partner 2 faces towards the adhesive layer 3 applied to the first joining partner 1, while a minimum spacing is maintained, i.e. no contact takes place, between the joining partners 1, 2, with a capillary volume 5 being formed. A parallel spacing between the second joining partner 2 and the adhesive layer 3 of the first joining partner 1 is provided, so that no wetting of the second joining partner 2 with adhesive takes place yet. A capillary volume 5 forms between the first joining partner 1 and the second joining partner 2 due to the selected minimum spacing.

According to the invention, a subsequent step shown in FIG. 1c) is provided in which an electric field 10 is generated by means of the electrode 7. As shown in FIG. 1d), this field 10 is supposed to be chosen such that a charge displacement 11 in and/or on the joining partner 2 is caused which in turn acts in an attracting manner on the polar adhesive layer 3. As FIG. 1d) further shows, the strength and polarity of this filed 10 are selected such that the charge displacement 11 in the second joining partner 2 is sufficient for attracting the polar adhesive located on the first joining partner 1 as an adhesive layer 3 in such a way that, overcoming its surface tension, it locally wets the gluing surface 2a of the second joining partner 2 without the adhesive layer 3 detaching from the first joining partner 1. For example, the electrode 7 is negatively charged with respect to the adhesive. The step shown in FIG. 1d) causes a spatially limited, i.e. local, wetting of the gluing surface 2a of the second joining partner 2. After the electrostatic field is switched off, an automatic full-surface spreading of the adhesive on the gluing surface 2a of the second joining partner 2 by means of capillary force occurs in the subsequent step shown in FIG. 1e). Thus, the local wetting 6 serves as a “seed” for the further full-surface wetting of the gluing surface 2a of the second joining partner 2. According to the invention, subsequent to the local wetting, a full-surface wetting of the gluing surface of the second joining partner 2 and spreading of the adhesive via the capillary volume 5 occurs due to the capillary force, starting from the location 6 of the local wetting, in order to form a composite 1, 2, 3 consisting of the first joining partner 1, the second joining partner 2 and the adhesive layer 3.

As shown in step 1f), a full-surface spreading filling the capillary volume 5 is obtained. As further shown in FIG. 1f), a first hardening step follows, in which the adhesive of the adhesive layer 3 hardens partially transparently by irradiation with UV light. The partial hardening, which is substantially limited to the edge region of the composite 1, 2, 3 is the result of the orientation of the UV emission of the UV light sources 13. This emission is directed towards the end faces, i.e. the narrow sides, of the composites and there substantially covers the exposed adhesive layer and thus, due to the partial hardening and solidification of the adhesive layer, prevents the adhesive from leaking out from the capillary volume without a full-surface hardening of the adhesive layer being required. After the “sealing of the edges” has taken place by hardening or curing the adhesive of the adhesive layer 3 located in the edge region of the composite 1, 2, 3, the composite 1, 2, 3 is removed from the receiving portion 8 and then, the adhesive of the adhesive layer 3 is hardened transparently and over its full surface by an irradiation with UV light 11 through the transparent joining partner 2. The radiation density of the UV light irradiation 11 is selected to be lower in the second step than in the first step in order not to jeopardize the optical properties of the adhesive of the adhesive layer 3 in the remaining part close to the center, outside the edge region irradiated in the first step.

1. An assembly for adhesively connecting substantially congruent gluing surfaces of a first and second joining partner over their full surface, comprising:
the first joining partner;
the second joining partner;
an adhesive layer of a polar, flowable adhesive applied to the gluing surface of the first joining partner;
means for holding the second joining partner above the adhesive layer of the first joining partner, such that the gluing surface of the second joining partner faces the adhesive layer on the first joining partner and is disposed so as to be spaced therefrom across an air gap, and the spacing defined by the air gap between the first joining partner and the second joining partner is dimensioned in such a way that a capillary volume is formed;
means for generating an electric field in order to cause, by means of electric influence, a local charge displacement on and/or in the second joining partner, and the charge displacement is suitable for attracting the polar adhesive in such a way that it wets the gluing surface of the second joining partner first in the area of the local charge displacement,
wherein the means for generating the electric field comprise an electrode, which is disposed on the side of the second joining partner facing away from the gluing surface and is electrically insulated from said partner.

2. The assembly according to claim 1, wherein means for applying the adhesive to the gluing surface of the first joining partner are also provided.

3. The assembly according to claim 2, wherein the means for holding the second joining partner comprise a receiving portion defining a contact surface for the second joining partner, and the electrode is at least partially embedded in the receiving portion.

4. The assembly according to claim 3, wherein the receiving portion is made from a plastic, preferably a polymer, more preferably a polyetherketone, such as polyaryletherketone, a polyhaloolefin, such as polytetrafluoroethylene, and/or a polyoxymethylene, such as a polyoxymethylene homopolymer.

5. The assembly according to claim 1, wherein the electrode has a pointed end pointing towards the gluing surface of the second joining partner.

6. The assembly according to claim 1, wherein the second joining partner is transparent, and the adhesive of the adhesive layer cures or hardens in a transparent manner.

7. The assembly according to claim 1, wherein the first joining partner is a display device, and its gluing surface is defined by an outer layer covering a display surface of the display device.

8. The assembly according to claim 1, wherein the second joining partner is a flat structure.

9. The assembly according to claim 1, wherein the second joining partner has a layer of polymethylmetacrylate.

10. The assembly according to claim 1, wherein the adhesive of the adhesive layer, at least during application, has a viscosity selected from the range of 500 mPas and 5000 mPas.

11. The assembly according to claim 1, wherein the adhesive of the adhesive layer is a chemically hardening adhesive, preferably a polymerization adhesive, such as a methyl methacrylate adhesive or a cyanoacrylate adhesive, or a polyaddition adhesive, such as an adhesive based on silicone polymer.

12. The assembly according to claim 1, wherein the means for holding the second joining partner comprise a vacuum holding device.

13. The assembly according to claim 1, wherein means for partially curing and/or hardening the adhesive layer are furthermore provided.

14. A method for adhesively connecting substantially congruent gluing surfaces of a first and second joining partner over their full surface, comprising the following steps:
providing the first and second joining partners;
applying a polar adhesive as a flowable adhesive layer to the gluing surface of the first joining partner;
disposing the second joining partner above the first joining partner using means for holding the second joining partner such that the gluing surface of the second joining partner faces the adhesive layer and is spaced therefrom across an air gap, wherein the spacing defined by the air gap between the first joining partner and the second joining partner is dimensioned in such a way that a capillary volume is formed;
generating an electric field by an electrode, which is disposed on the side of the second joining partner facing away from the gluing surface and is electrically insulated therefrom, in order to cause, by means of electric influence, a local charge displacement on and/or in the second joining partner;
first wetting of the gluing surface of the second joining partner in the region of the local charge displacement by the polar adhesive being attracted due to the charge displacement;
full-surface spreading of the adhesive and full-surface wetting of the gluing surface of the second joining partner, starting from the location of the local wetting, by means of capillary force in the air gap;
curing or hardening of the adhesive layer.

15. The method according to claim 14, wherein the step of generating an electric field precedes the wetting step.

16. The method according to claim 14, wherein the step of curing or hardening includes a first step of partially curing or hardening the adhesive layer and a second subsequent step of the further, preferably full-surface, curing or hardening of the adhesive layer, and that further, an intermediary removing step, i.e. a step interposed between the first and second steps, is provided, in which the composite of the first and second joining partners and the adhesive layer is removed from the means for holding the second joining partner and/or the electrode.
